(19) United States
(12) Patent Application Publication
(10) Pub. No.: US 2026/0057050 A1
(43) Pub. Date: Feb. 26, 2026

(54) FINE-GRAINED AUTHORIZATION AS A SERVICE VIA RELATIONSHIP- BASED ACCESS CONTROL WITHIN A MULTI-TENANT SYSTEM

(71) Applicant: OKTA, INC., SAN FRANCISCO, CA (US)

(72) Inventors: Damian Ezequiel Schenkelman, Buenos Aires (AR); Jonathan Cornelius Allie, Newton, NC (US); Yamil Asusta, San Juan (PR); Javier Alberto Centurion, Escobar (AR); Raghd Hamzeh, Toronto (CA); Sebastian Iacomuzzi, London (GB); Matias Adrian Woloski, Punta del Este (UY)

(21) Appl. No.: 19/373,474

(22) Filed: Oct. 29, 2025

Related U.S. Application Data
(63) Continuation of application No. 18/485,175, filed on Oct. 11, 2023.
Application No. 18/485,175 is a continuation-in-part of application No. 17/733,644, filed on Apr. 29, 2022, now Pat. No. 12,443,741.

(51) Int. Cl. G06F 21/31; G06F 21/60

(52) U.S. Cl. CPC G06F 21/31; G06F 21/604; G06F 2221/2141

(57) ABSTRACT

An authorization is performed based on data types—an authorization model, and relationship tuples—that are applicable across different organizations. Each organization wishing to use a system for authorization specifies its own authorization models representing types of objects that can exist within the organization and types of relations those objects can have. When a given organization submits an authorization query to determine whether a given user and a given object are in a given type of relation within that organization, the system analyzes the authorization model and relationship tuples to make the determination. Query response latency may be reduced through techniques such as geographic distribution of servers and sharding of data so that the data for a given query can be found within the same shard.

### CROSS REFERENCE

The present application for patent is a Continuation of U.S. patent application Ser. No. 18/485,175 by SCHENKELMAN et al., entitled “FINE-GRAINED AUTHORIZATION AS A SERVICE VIA RELATIONSHIP-BASED ACCESS CONTROL WITHIN A MULTI-TENANT SYSTEM” filed Oct. 11, 2023, which is Continuation-In-Part of U.S. patent application Ser. No. 17/733,644 by SCHENKELMAN et al., entitled “FINE-GRAINED AUTHORIZATION AS A SERVICE VIA RELATIONSHIP-BASED ACCESS CONTROL WITHIN A MULTI-TENANT SYSTEM” filed Apr. 29, 2022, which is assigned to the assignee hereof, and expressly incorporated by reference in its entirety herein.

### FIELD OF ART

This disclosure relates generally to the field of software systems, and more specifically, to systems for determining authorization for users and objects within a multi-tenant system.

### BACKGROUND

Authorization processes determine whether a user is permitted to perform a given action on an object. Authorization logic is traditionally hand-coded for each individual application or system for which authorization is desired and logic to make authorization decisions typically shares both code and data stores with the rest of the application's logic, which is time-consuming and error-prone, and not portable across different systems.

### SUMMARY

An authorization system provides authorization services for multiple tenants/organizations. The authorization is performed based on standardized data types—an authorization model, and relationship tuples—that are applicable across the different organizations. Each organization wishing to use the system for authorization, creates one or more tenants. In each tenant, they specify its own authorization model(s) (representing the types of objects that can exist within the organization's system, and which types of relations those objects can have to users and to each other) and relationship tuples (representing the existing user/object and object/object relationships within the organization's system). When a given organization submits an authorization query to determine whether a given user and a given object have a given type of relation within that organization (e.g., whether the user can perform a particular action on the object), the system analyzes the authorization model and relationship tuples, making inferences according to rules of the authorization model to determine whether the relation exists between the user and the object.

In some embodiments, the authorization models are specified using a domain-specific language (DSL) that uses Boolean operators such as “or” disjunctions to specify which types of relations imply which other types of relations. The DSL simplifies the task of defining authorization models within a given domain, easing burdens on users of the authorization system to specify those relationships.

In some embodiments, an organization may use multiple authorization models (e.g., different versions of a particular domain model), and the authorization system may compare query outcomes using the identifiers of the different authorization models as input, for purposes such as phased rollout/rollback of authorization logic.

The various relationship tuples may be created by software designed to be compatible with the authorization system, e.g., in response to actions by the various users, such as document creation, the specification of user membership within a particular user group, and the like. In some embodiments, the relationship tuples are distributed across database shards such that the data needed to evaluate any given database query required to respond to an authorization query is available within a single shard, thereby improving computational parallelism and decreasing query processing time.

In some embodiments, the DSL may specify conditions under which a given user of an organization's system (as opposed to a user of the authorization system itself) may be permitted to create relationship tuples. For example, a particular organization may use the DSL to specify that one of the organization's users with a certain relation to an object is permitted to create other relationship tuples pertaining to that object.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

A method by an apparatus is described. The method may include receiving, from an administrator of a tenant of the multi-tenant system, input indicative of an authorization model for the tenant, the authorization model indicating types of objects of the tenant and types of relations that the types of objects have with users of the tenant, receiving a set of multiple relationship tuples indicating a set of multiple relations between a set of multiple users and a set of multiple objects, receiving a request to determine whether a user of the tenant is authorized to perform an action on an object, making a determination of whether the user is authorized to perform the action on the object, the determination being made in accordance with the authorization model and a set of relationship tuples of the set of multiple relationship tuples, the set of relationship tuples based on the request, and responding to the request in accordance with the determination.

An apparatus is described. The apparatus may include one or more memories storing processor executable code, and one or more processors coupled with the one or more memories. The one or more processors may individually or collectively operable to execute the code to cause the apparatus to receive, from an administrator of a tenant of the multi-tenant system, input indicative of an authorization model for the tenant, the authorization model indicating types of objects of the tenant and types of relations that the types of objects have with users of the tenant, receive a set of multiple relationship tuples indicating a set of multiple relations between a set of multiple users and a set of multiple objects, receive a request to determine whether a user of the tenant is authorized to perform an action on an object, make a determination of whether the user is authorized to perform the action on the object, the determination being made in accordance with the authorization model and a set of relationship tuples of the set of multiple relationship tuples, the set of relationship tuples based on the request, and respond to the request in accordance with the determination.

Another apparatus is described. The apparatus may include means for receiving, from an administrator of a tenant of the multi-tenant system, input indicative of an authorization model for the tenant, the authorization model indicating types of objects of the tenant and types of relations that the types of objects have with users of the tenant, means for receiving a set of multiple relationship tuples indicating a set of multiple relations between a set of multiple users and a set of multiple objects, means for receiving a request to determine whether a user of the tenant is authorized to perform an action on an object, means for making a determination of whether the user is authorized to perform the action on the object, the determination being made in accordance with the authorization model and a set of relationship tuples of the set of multiple relationship tuples, the set of relationship tuples based on the request, and means for responding to the request in accordance with the determination.

A non-transitory computer-readable medium storing code is described. The code may include instructions executable by a processor to receive, from an administrator of a tenant of the multi-tenant system, input indicative of an authorization model for the tenant, the authorization model indicating types of objects of the tenant and types of relations that the types of objects have with users of the tenant, receive a set of multiple relationship tuples indicating a set of multiple relations between a set of multiple users and a set of multiple objects, receive a request to determine whether a user of the tenant is authorized to perform an action on an object, make a determination of whether the user is authorized to perform the action on the object, the determination being made in accordance with the authorization model and a set of relationship tuples of the set of multiple relationship tuples, the set of relationship tuples based on the request, and respond to the request in accordance with the determination.

In some examples of the method, apparatus, and non-transitory computer-readable medium described herein, the input includes at least one natural language message indicating at least one rule of the authorization model and the at least one rule indicates the types of objects of the tenant and the types of relations that the types of objects may have with the users of the tenant.

Some examples of the method, apparatus, and non-transitory computer-readable medium described herein may further include operations, features, means, or instructions for generating the authorization model from the at least one natural language message using an artificial intelligence model, where the authorization model may be expressed with a domain-specific language (DSL).

Some examples of the method, apparatus, and non-transitory computer-readable medium described herein may further include operations, features, means, or instructions for outputting an indication of the DSL to the administrator in response to receiving the at least one natural language message and receiving, from the administrator, second input indicative of an approval of the DSL, or indicative of a modification to the DSL.

In some examples of the method, apparatus, and non-transitory computer-readable medium described herein, the second input includes a natural language message indicative of the modification to the DSL or the second input includes the modification to the DSL.

Some examples of the method, apparatus, and non-transitory computer-readable medium described herein may further include operations, features, means, or instructions for outputting a visualization of the authorization model, where receiving the second input may be based on the visualization.

In some examples of the method, apparatus, and non-transitory computer-readable medium described herein, the at least one natural language message includes a set of multiple natural language messages indicating a set of multiple rules of the authorization model and each message of the set of multiple natural language messages corresponds to a respective rule of the set of multiple rules.

In some examples of the method, apparatus, and non-transitory computer-readable medium described herein, receiving the input may include operations, features, means, or instructions for receiving the authorization model expressed with a domain-specific language (DSL).

Some examples of the method, apparatus, and non-transitory computer-readable medium described herein may further include operations, features, means, or instructions for outputting a first query and a second query, the first query for a first type of relationship tuple associated with a first type of user identifier and the second query for a second type of relationship tuple associated with a second type of user identifier, where the set of relationship tuples includes relationship tuples of the first type or the second type.

In some examples of the method, apparatus, and non-transitory computer-readable medium described herein, making the determination may include operations, features, means, or instructions for performing a first evaluation with the set of relationship tuples based on the set of relationship tuples including the relationship tuples of the first type and performing a second evaluation with the set of relationship tuples based on the set of relationship tuples including the relationship tuples of the second type, the second evaluation being different from the first evaluation.

In some examples of the method, apparatus, and non-transitory computer-readable medium described herein, receiving the set of multiple relationship tuples may include operations, features, means, or instructions for receiving a request to create a relationship tuple at a first time based on the relationship tuple not existing in the multi-tenant system prior to the first time and storing the relationship tuple in the multi-tenant system with a first timestamp corresponding to the first time.

Some examples of the method, apparatus, and non-transitory computer-readable medium described herein may further include operations, features, means, or instructions for receiving a request to delete the relationship tuple, the request including a second timestamp and deleting the relationship tuple in response to the request based on a second time corresponding to the second timestamp occurring subsequent to the first time corresponding to the first timestamp.

Some examples of the method, apparatus, and non-transitory computer-readable medium described herein may further include operations, features, means, or instructions for determining an evaluation cost associated with making the determination, where the evaluation cost may be based on level of complexity associated with the request and determining whether the request applies to a service level agreement between the multi-tenant system and the tenant based on the evaluation cost satisfying a threshold.

In some examples of the method, apparatus, and non-transitory computer-readable medium described herein, receiving the set of multiple relationship tuples may include operations, features, means, or instructions for receiving the set of multiple relationship tuples from software components designed to operate with the multi-tenant system, the set of multiple relationship tuples received in response to actions associated with the users of the tenant.

In some examples of the method, apparatus, and non-transitory computer-readable medium described herein, receiving the set of multiple relationship tuples may include operations, features, means, or instructions for receiving the set of multiple relationship tuples indicating the set of multiple relations between the set of multiple users and the set of multiple objects, where a relationship tuple includes a relation between a first user and a first object, a relation between a second user and the first object, a relation between the first user and the second user, or a relation between the first user and a group.

### BRIEF DESCRIPTION OF DRAWINGS

FIG. 1 illustrates an environment in which various distinct organizations use a multi-tenant system to determine whether particular actions of particular users are authorized for that organization, according to one embodiment.

FIG. 2 is a high-level block diagram illustrating a multi-tenant system using natural language messages to determine an authorization model, according to one embodiment.

FIG. 3 is a high-level block diagram illustrating physical components of a computer used as part or all of the multi-tenant system, client device, or resource server from FIG. 1, according to one embodiment

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

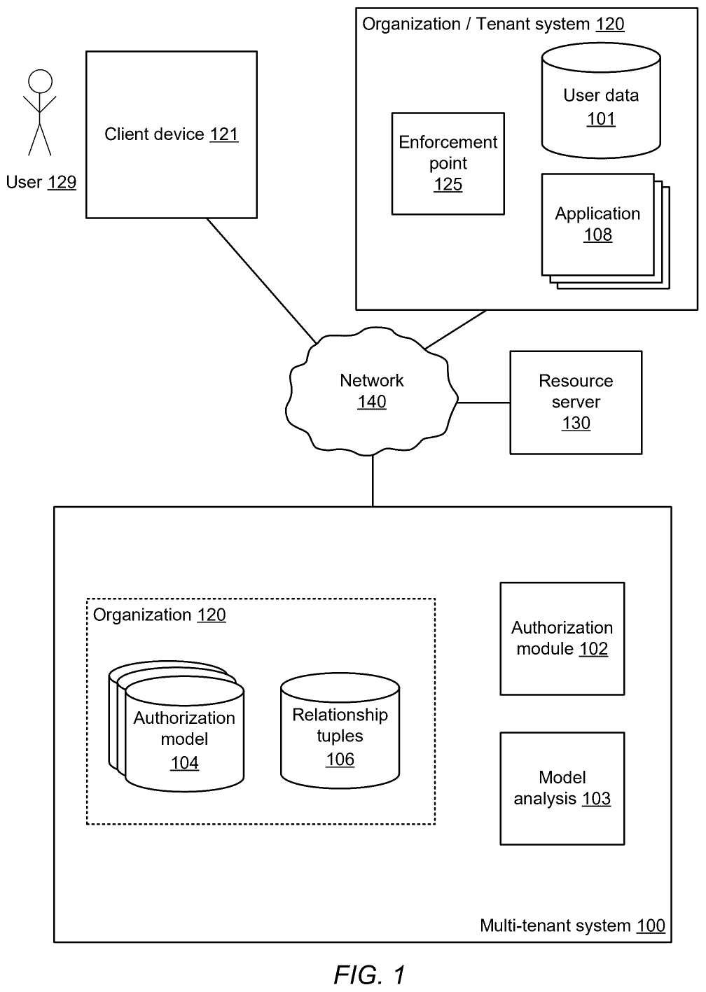

FIG. 1 illustrates an environment in which various distinct organizations use a multi-tenant system to determine whether particular actions of particular users are authorized for that organization, according to one embodiment. Each organization 120 provides applications 108. Applications 108 are used by a number of client devices 110 used by different users 129 of the organization (e.g., if the application is a document authoring application, users of the application could be direct consumers, as in a business-to-consumer (“B2C”) scenario, or employees of the companies that are customers of the application, as in a business-to-business (“B2B”) scenario). The users 129 use the client devices 110 to perform different actions, such as using particular applications of the organization 120, operating on particular resources in those applications 108. For example, in the case of a document sharing application users might create and delete documents and folders and share them with other users. In the case of a social network, users might post pictures and view their friends' pictures. As part of processing device requests, the organization 120 needs to make decisions about whether the action of a user 129 is authorized (or, more broadly, whether there exists a given relation between two entities, such as a user and an object), which typically happens at an “enforcement point” 125. An enforcement point 125 is a component in a system that enforces authorization decisions, rejecting requests that are not authorized and routing/letting through those that are authorized. The client device 121 of the user makes requests to the organization system and when requests reach the enforcement point 125, the enforcement point makes a request to the multi-tenant system 100 that provides it with authorization-determination services. The authorization module 102 responds to the authorization enforcement point 125 with a determination of whether the action is authorized, and the authorization enforcement point 125 (or other software component that uses it) can then take action in accordance with the authorization determination, such as by allowing the user to proceed to use an application. These aspects are now discussed in additional detail.

The organization 120 is an entity, such as a business, a school, a governmental agency, or the like, that has a number of affiliated users 129, such as employees, consumers or employees of the organization's customers. Although for simplicity FIG. 1 illustrates only a single user 129 and client device 121, there may be any number of either.

The client devices 121 are computing devices such as smart phones, laptop computers, desktop computers, or any other device that can execute or make network requests (e.g., as part of using a browser) to software requiring authorization decisions.

The resources accessed by the users 129 may include resources external to the organization 120 itself. For example, a resource server 130 may provide access to a resource, such as a web-based application (e.g., MICROSOFT OFFICE 365™), a service, a database, a document, or the like.

The organization 120 may store user data 101 that include a set of identities of known users that are associated with the organization. The user data 101 may include a form of identity on the organization 120 such as a username, as well as other credential data associated with a user, such as a user password and/or information derived therefrom (such as an encrypted form of the password). The user data 101 may also include many other types of data about users, such as the users' role(s) or group(s) within the organization 120 (e.g., “Engineering”, “Legal”, “Manager 2”, “Director”, or the like). Some or all of the user data 101 may additionally or alternatively be stored as part of the relationship tuples 106, described in more detail below.

An organization 120 may have a set of applications 108 that its users can use. The applications 108 may use information about their respective domains to add information to the relationship tuples 106, as described in more detail below.

As noted, the multi-tenant system 100 provides authorization services for the different organizations 120 that are tenants of the system. Since each organization 120 can have its own rules and facts for determining whether a particular action or relationship is authorized for that organization, the multi-tenant system 100 stores a set of organization-specific data for each organization 120 that is a tenant. For example, FIG. 1 illustrates that the multi-tenant system 100 stores authorization models 104 and relationship tuples 106 on behalf of each organization 120, for which it provides authorization services. The authorization model 104 defines the types of objects that can exist within the organization 120 and the types of relationships that those objects can have with users or other objects. The relationship tuples 106 serve as the “facts” that determine (when querying the system) whether a user has a particular relationship to an object based on the authorization model 104. Together, an authorization model 104 and relationship tuples represent a particular domain in which authorization requests can be analyzed. The authorization model 104 and relationship tuples 106 are now described in additional detail.

The authorization model 104 expresses which types of objects can exist within a given tenant system/organization 120, and which types of “relations” those objects can have, as well as which types of relationships imply which other types of relationships; this is defined based on the organization's system. A “relation” is a particular semantic association between two entities within the system, such as ownership, the right to view or print, the right to use, the fact one user “manages” another user, or the like. The entities can represent users 129 of the system, or non-user objects, including collectives such as groups of users or objects.

In one embodiment, the authorization model 104 is specified using a domain-specific language (“DSL”). The DSL defines the types of objects that can be reasoned about by the authorization module 102 for that tenant, and also expresses the types of relations that those types of objects can have with users or other objects. In one embodiment, the DSL expresses which relations are inferred by which other relations using Boolean operators such as “or”, “and”, and “but not”. The primary users for the DSL will be developers working for each organization. For a multi-tenant system, simplifying authorization model development and error minimization is fundamental, as it allows all organizations to define their own authorization models autonomously and with confidence. A DSL with a small surface area (e.g., few keywords) that relies on constructs (boolean operators) with which developers are familiar when defining relations is a key component of making the multi-tenant system 100 valuable

Listing 1, below, provides a specific—though purposely simplified—example of expressing a portion of an authorization model 104 using such a DSL:

Listing 1

```
  type doc:
        relations:
              define creator as self
              # all creators can write
              define writer as self or creator
              # all writers can read
              define reader as self or writer or reader from parent
              # parent folder
              define parent as self
  type folder:
        relations:
              define reader as self
```

In this example, the line “type doc:” specifies that “doc” is a type of object (e.g., representing a document) that can exist within the organization's system 120 that is associated with the authorization model 104. The following lines express that the types of relations that a “doc” object can have with a user include “creator”, “writer”, and “reader” (e.g., respectively expressing whether a particular user is a creator of the document, can write to the document, or can read from the document). The DSL keyword “self” means that users have a relationship to an object if tuples exist that directly imply that relationship. For example, given the line “define creator as self” and the tuple (user: “jane”, relation: “creator”, object: “doc: roadmap”), Jane, has a relationship “creator” to the “roadmap” document. It is possible to define a relation without self, e.g., define write as edit. This is useful for automatically implied relationships, such as for alias cases. In this example, even if a tuple (user: “john”, relation: “write”, object: “doc: slides”) exists, when querying the system for an authorization decision user John will not have a “write” relationship to doc: slides because only through having an “edit” relationship will users have a “write” relationship. Conceptually, this makes relations that define “self” assignable via tuples. The operator “x from y” refers to the set of users that have relationship x with the object y. In relationship definitions “type t define z as x from y”, users will have relationship z with objects of the type if they have relationship x with objects that have relationship y with the object of type t. For example, given the tuples (user: “folder: root”, relation: “parent”, object: “doc: slides”) and (user: “john”, relation: “reader”, object: “folder: root”) and the prior example, the user “john” has a relationship “reader” with object “doc: slides” because: “john” has a relationship “reader” with “folder: root”, “folder: root” has a relationship “parent” with “doc: slides” and the type “doc” is defined “define reader as self or writer or reader from parent”, so readers of the folder that is parent to the document can read the document.

The relationship tuples 106 represent the “facts” about the user/object relations within the associated organization 120 and form the factual basis for determining whether a given relationship holds. Relationship tuples 106 are (<user>, <relationship>, <object>) triples, representing the fact that the given user has a relation with the given object. For example, one relationship tuple for a particular organization might be (user 1234, canUse, applicationABC), indicating that the user with the unique ID “user 1234” has a relation “canUse” with respect to the object with unique identifier “applicationABC” (e.g., that that user is permitted to use that particular application). As another example, another relationship tuple could be (user1234, creator, documentXYZ), indicating that user “user1234” is the creator of the document “documentABC.”

In some embodiments, user can specify a group of users, such as all members of the “finance” group. The syntax for the <user> tuple component in that case is <object> #<relation>. For example: group:managers #member specifies the set of all users that have a member relationship to the “group:managers” object.

The relationship tuples 106 can be created by software components having knowledge of the domain represented by the authorization model 104 (e.g., the applications 108). Continuing the above example of a domain that includes documents and access thereto, a software component creating (or observing the creation of) a document “d₁” for a user “u₁” might create the relationship tuple (u₁, creator, doc: d₁). As another example, a software component observing that user “u₁” was added to a group named “accounting” within the organization 120 might create a relationship tuple (u), member, group: accounting). In this way, the software used by the organization 120 is responsible for creating the relationship tuples 106 that are later used to evaluate authorization requests.

In some embodiments, the DSL includes predefined names (e.g., “$tupleReader”, “$tupleWriter”) for a relation specifying the ability for users of the organization's system 120 (as opposed to users of the authorization system) to read/write tuples to/from the relationship tuples 106 for the user's organization 120. For example, if Listing 1, above, included the line “define $tupleWriter as creator”, that would specify that a user u₂ is permitted to write tuples related to the documents for which he has a creator relationship (that is, documents d for which the authorization system returns true to a query asking “does u₂ have a creator relationship to object d” (u₁, creator, d)). In this case, the client device can directly read/write to the multi-tenant system 100 passing an authorization credential that the multi-tenant system will use to determine if u₂ has the required permission to perform the action. The benefit for developers of the organization's system is that for certain use cases they do not need a backend component to be developed and maintained and can instead read and write to the multi-tenant system directly. This allows an organization 120 to specify, via its authorization model 104, that users of the organization's system are permitted to write tuples about given objects (e.g., documents) to the relationship tuples 106 if they have a certain specified relation (e.g., “creator”) with respect to those objects.

The multi-tenant system 100 has an authorization module 102 that accepts authorization queries originating from users 129 and responds with a determination of whether the relation specified by the query is in fact authorized according to a given authorization model 104 and the relationship tuples 106 for that organization. The authorization queries can be conceptualized as tuples (<authModel>, <user>, <relationship>, <object>), where <user>, <relationship>, and <object> constitute the relation whose authorization is to be determined, and <authModel> represents the authorization model 104 according to which it is determined. The <authModel> is one of the authorization models 104 of the organization 120 to which the querying user 129 belongs.

Continuing the example of Listing 1, a user 129 might use her client device 121 to attempt to write to the document d₁. The client device 121 (or within another system with knowledge of the attempt, such as a server on which the document d₁ resides, or the authorization enforcement point 125) sends a corresponding authorization query to the authorization module 102 on the multi-tenant system 100. In the prior example, the authorization query might be the tuple (m₁, u₁, writer, d₁), where m₁ is one of the authorization models 104 of the organization 120 to which the user 129 belongs, u is the unique identifier of the user 129 within the organization 120, “writer” represents the ability to write to a document, and d₁ is the document being written to. The exact format and contents of the query could vary in different embodiments. For example, rather than sending the identifier of the authorization model 104, the component sending the authorization query might simply send an identifier of the organization 120 and leave it up to the authorization module 102 to determine which authorization model 104 to use for the that organization.

In order to determine whether a particular <user, relation, object> tuple represents an authorized activity, the authorization module 102 evaluates the sets of users that have a relationship to the object by (recursively) following the definitions of each relation, and considering both boolean operators and user sets, as described above. The response to the query is true if the user is part of the set of users that have a relationship to the object, and false otherwise. Appendix A, below, specifies pseudocode for making this determination, according to some embodiments.

In some embodiments, the multi-tenant system 100 may store multiple authorization models 104 for a single organization 120. For example, there could be separate versions of a single conceptual authorization model, such as a current, stable authorization model used in production, and a newer authorization model that extends, simplifies, or otherwise revises the existing model for different versions, but which is not yet fully tested. In embodiments permitting separate versions of the same conceptual authorization model 104, a model analysis module 103 compares the different versions of the models to determine whether, or in what respects, the versions produce different outcomes. This comparison can be used for purposes such as change management and auditing; performing “what if?” analyses to assess how a particular authorization request will be handled with different models; and/or progressively rolling out changes in authorization policies and evaluating the impact of those changes, rolling the changes back if they result in inaccuracies or other undesirable results.

In some embodiments, the multi-tenant system 100 partitions data (such as the relationship tuples 106) across multiple shards distributed across different servers. Each shard may be assigned one or more predetermined shard keys, each of which is composed of the ID of the particular tenant organization 120, a user type (either a single user or a set of users, as described above)”, a relation ID, and an object ID. Thus, as part of the recursive resolution discussed above, when the authorization module 102 needs to query relationship tuples from the database, the authorization module computes shardKey=f (tenant, user, relation, object), and all the data for resolving the query can be found in the shard with ID shardKey. This beneficially reduces the time and processing that it takes to find the data to resolve the authorization query, as well as increasing parallelization and overall throughput due to the distribution of the shards across different servers.

A user of the multi-tenant system 100 may select (e.g., identify, determine) a database, also referred to herein as a datastore, for storing the tuples within the multi-tenant system 100. The user may be associated with an organization (e.g., a tenant of the multi-tenant system 100) and may have one or more permissions that enable the user to define authorization models for the organization (e.g., the user may be an administrator, a developer, a vendor). The selected database may be executing (e.g., running) on multiple servers. That is, the database may be a sharded datastore that enables (e.g., encourages, promotes) increased distribution of records (e.g., tuples) to provide increased latency predictability across multiple shards in the multi-tenant system 100 (e.g., may provide relatively predictable latency across different shards in the multi-tenant system 100). The distribution of corresponding records for the tenant may be determined by a Primary Key (PK) and a Sort Key (SK). When combined, the PK and SK may be a unique identifier. In some examples, the PK may indicate (e.g., may be used to determine) a shard that stores a record, and an associated SK may store a sorted list of records (e.g., all records) that share the same PK.

In some examples, a tuple may be described as the combination of an object, relation, and user. That is, a tuple may be a row of the database with one or more fields (e.g., object, relation, user), which may each correspond to a column of the database. Various parameters may be used to describe a user within a tuple. For example, a user may be described using one of a user_id parameter or userset parameter, in which the user_id parameter may correspond to an arbitrary value and userset parameter may correspond to a group, such as a combination of an object and a relation. In some examples, a schema for sorting tuples across multiple shards may provide increased performance. For example, some schemes for sorting tuples may distribute workloads to provide relatively consistent performance of the multi-tenant system 100. Such schemas, however, may have a disproportionate number of user_id parameters than userset parameters. For example, the userset parameter may correspond to a group, whereas the user_id parameter may correspond to a user (e.g., a single user). In other words, a quantity of users described via user_id may be disproportionate from a quantity of users described via userset.

In such examples, the multi-tenant system 100 may evaluate tuples based on parameters (e.g., which parameters) are included in the tuple. In other words, the multi-tenant system 100 may evaluate tuples based on a tuple type associated with the tuple. For example, for an authorization evaluation (e.g., any authorization evaluation, which also referred to herein as a CHECK) to be evaluated, some input (e.g., an object, relation and user input) may be provided to the multi-tenant system 100 to determine (e.g., discover) associated tuples. The associated tuples may include the user_id parameter or the userset parameter. Tuples that include the user_id parameter may be compared for equality with the user input, while tuples that include the userset parameter may undergo another (e.g., different) evaluation process. For example, tuples that include the userset parameter may undergo an evaluation process (e.g., a separate evaluation process) for each of the usersets provided (e.g., for each value of the userset parameter provided). In some examples, segmenting tuples having one or more of the same object, relation pairs into different categories based on the user parameter (e.g., whether the tuples include the user_id parameter or the userset parameter) may lead to the records of a tenant being stored in different shards. In such examples, a ratio of associated tuples with the user_id parameter to associated tuples with the userset tuple may be disproportionate. As such, discovering userset tuples may not be impacted (or may be impacted less) by a quantity of user_id tuples and having the same object, relation pair. That is, determining associated tuples with the userset parameter may not be impacted (or may be impacted less) by a quantity of associated tuples having the user_id parameter and having the same object, relation pair. Segmentation of tuples into categories based on the user parameter may lead to the multi-tenant system 100 making multiple queries (e.g., two queries instead of one) against the database, however, a computational cost of evaluating the multiple queries (e.g., each query individually) may be static (e.g., relatively consistent) given that the user_id parameter may be searched for directly (e.g., based on an object, relation pair) instead of being searched for in-between multiple tuples (e.g., in-between all possible tuples associated with the object, relation pair).

As an illustrative example, the multi-tenant system 100 may receive some input from the user 129 (e.g., an administrator of the multi-tenant system 100). The input may be indicative of an authorization model for the tenant. That is, the administrator (e.g., tenant) may specify an authorization model for the tenant. The authorization model may indicate types of objects of the tenant and types of relations that the types of objects have with users of the tenant. In other words, the authorization model may represent the types of objects that may exist within the organization's system, and which types of relations those objects may have to users and to each other. Additionally, the multi-tenant system 100 may receive (e.g., from the administrator, from one or more other users of the tenant, or via one or more automated processes) an indication of one or more relationship tuples. The relationship tuples may indicate relations between users and objects. For example, one or more of the relationship tuples may represent an existing user/object and object/object relationships within the organization's system. In some examples, one or more tuples may indicate relations between users (e.g., one or more users may be related to one or more other users) and may indicate relations between one or more objects of a user and other users (e.g., one or more objects of a user may be related to one or more other users). Additionally, in some examples, a user or object may be associated with a group. That is, one or more tuples may indicate relations between users and groups or between objects and groups, or some combination thereof. In other words, multiple relationship tuples may indicate multiple relations between multiple users and multiple objects, where a relationship tuple may include a relation between a first user and a first object, a relation between a second user and the first object, a relation between the first user and the second user, or a relation between the first user and a group.

The multi-tenant system 100 may receive a request to determine whether the user 129 of the multi-tenant system 100 tenant is authorized to perform an action on an object. In response to the request, the multi-tenant system 100 tenant make a determination of whether the user 129 is authorized to perform the action on the object. For example, the multi-tenant system 100 tenant may make the determination in accordance with the authorization model and a set of associated relationship tuples that is based on the request. The set of associated relationship tuples may include one or more of the relationship tuples of the multiple relationship tuples for the tenant system 120 which may be associated with the request. The associated relationship tuples may be obtained in response to the authorization module 102 querying relationship tuples from the database (e.g., based on the request). For example, a userType associated with the request may be one of “user” or “userset,” in which “user” may correspond to a representation of the user_id parameter, while “userset” may correspond to a representation of the userset parameter. Accordingly, records for the request may be represented in the database as PK: TUPLE_{TENANT_ID} | {object} #{relation} | {userType} and SK: {user}. Accordingly, the queries made by the authorization module 102 may evaluate a CHECK using a first fetch (Fetch 1) for records by PK and SK where userType=“user” and a second fetch (Fetch 2) for records (e.g., all records) by PK where userType=“userset”. In other words, the authorization module 102 may output a first query (Fetch 1) and a second query (Fetch 2) in which the first query is for a first type of relationship tuple associated with a first type of user identifier (e.g., is for user_id tuples in which a user is defined via the user_id parameter) and the second query is for a second type of relationship tuple associated with a second type of user identifier (e.g., is for userset tuples in which a user is defined via the userset parameter). Accordingly, the retrieved set of associated relationship tuples may include user_id tuples or userset tuples, or both. If the set of tuples includes relationship tuples of the first type (e.g., user_id tuples), the multi-tenant system 100 may perform a first evaluation. For example, the multi-tenant system 100 may compare the user_id tuples for equality with the user input. If the set of tuples includes relationship tuples of the second type (e.g., userset tuples), the multi-tenant system 100 may perform a second evaluation (different from the first evaluation). For example, the multi-tenant system 100 may perform one or more other evaluation processes for each of the userset tuples. The multi-tenant system 100 may respond to the request in accordance with the determination. For example, the multi-tenant system 100 may authorize or refrain from authorizing the user to perform the action on the object based on the determination.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

Although the multi-tenant system 100 is illustrated in FIG. 1 as a single entity, it may in practice be composed of multiple server systems, routers, load balancers, and the like. Additionally, in some embodiments the multi-tenant system 100 is composed of servers that are distributed in a number of different geographic zones (e.g., two in North America, three in Europe, 4 in Asia, 2 in Africa, or the like) and the multi-tenant system is configured to route traffic from clients to the closest zone (where “closest” is defined in terms of network speed); this minimizes network latency when communicating with organization's systems 120 in different geographic areas, relative to having a single centralized system, while also increasing availability through redundancy in case of failure of a single region. For scenarios where data location is a concern for privacy and/or compliance reasons, the multi-tenant system can be deployed to specific select geographic zones (e.g., 4 in Europe).

The multi-tenant system 100 may use multiple databases, for example, for one or more tenants. The multiple databases may be located in multiple (e.g., different) geographic zones. Additionally, or alternatively, the multi-tenant system 100 may use multiple servers (e.g., for the one or more tenants) that may be located in multiple geographic zones. In other words, records for a tenant may be partitioned at the database level (across multiple databases) or at the shard level (across multiple servers of a same database). Additionally, or alternatively, records for a tenant may be partitioned at the database level and the shard level. In other words, the records for the tenant may be partitioned at the database level and may also be sharded across multiple geographical zones (e.g., across different locations, such as in different countries or different regions of the world). Accordingly, the multiple databases (or the multiple servers) may sync to each other.

In some examples, to provide increased accuracy and reduced latency across multiple databases (or multiple shards), the multi-tenant system 100 may support a schema to implement an ordered ledger (e.g., a changelog) across the multiple active databases (or across multiple different shards of one or more databases). For example, the multi-tenant system 100 may use the changelog as an ordered ledger of operations related to tuples. In such examples, each record of the ledger may include a tuple, a corresponding operation (created or deleted), and a time the operation occurred. The changelog may therefore be able to re-create a state of the tuple (or multiple tuples) at a point in time (e.g., any point in time). For example, the multi-tenant system 100 may operate in multiple regions (e.g., may operate multi-regionally) and may leverage global database tables to synchronize records across the multiple regions (e.g., all the regions of presence). In some examples, however, some databases may lack a mechanism for timestamps. Accordingly, timestamps may be provided from application servers, which may not share the same clock and may be prone to clock drift. Accordingly, systems that use such databases may also lack a mechanism for providing an order based on time (e.g., using time) if time differs across multiple components (e.g., servers, databases) of the system. Additionally, multiple databases synchronizing changes of tuple actions may lead to an incorrect state for a particular tuple.

In some examples, rather than relying exclusively on timestamps (as timestamps may drift) to provide an order for operations, the multi-tenant system 100 may support one or more safeguards for operations regarding tuples. Such safeguards may provide for increased ordering accuracy. A safeguard may include the multi-tenant system 100 enabling a tuple to be created (e.g., only be created) if the tuple did not previously exist in the system. Accordingly, if a tuple (also referred to herein as a relationship tuple) is created in multiple regions (e.g., two regions) at the same time, a last tuple created may be stored (e.g., a most recent one of the two tuples written to the datastore may prevail). In some examples, when a tuple is written to the datastore, the tuple may include a timestamp that serves as an approximate time for the creation. Another safeguard may include the multi-tenant system 100 enabling a tuple to be deleted (e.g., only be deleted) if the tuple previously existed in the multi-tenant system 100 and the timestamp of the tuple being provided by the request is greater (corresponds to a subsequent time) than the timestamp of the previously existing tuple stored in the tuple record. Such a safeguard may reduce a likelihood of tuples being deleted before the tuples are created and may be less susceptible to clock drift impacting the state of a tuple (e.g., an individual tuple). In some examples, a lack of such safeguards may lead to the multi-tenant system 100 having a changelog with one or more entries (e.g., “deleted, created”) for a particular tuple that may no longer exist in the multi-tenant system 100 (e.g., and therefore the changelog may be incorrect).

As an illustrative example, at a first time, the multi-tenant system 100 may receive an indication of an operation regarding a relationship tuple. The operation may correspond to a request to create a relationship tuple. In such an example, the multi-tenant system 100 may enable the tuple to be created (or may support the request being received) based on the relationship tuple not existing in the multi-tenant system 100 prior to the first time. The multi-tenant system 100 may store the relationship tuple in the multi-tenant system 100 with a first timestamp corresponding to the first time. The multi-tenant system 100 may receive an indication of a second operation regarding the relationship tuple. The second operation may correspond to a request to delete the relationship tuple. The request to delete the relationship tuple may include a second timestamp. In response to the request to delete the relationship tuple, the multi-tenant system 100 may delete the relationship tuple based on a second time corresponding to the second timestamp occurring after (e.g., subsequent to) the first time corresponding to the first timestamp.

In some examples, the multi-tenant system 100 may support service level agreement (SLA) budget tracking based on resolution cost. For example, the multi-tenant system 100 may have an SLA with the tenant system 120 in which the multi-tenant system 100 may resolve a query (e.g., a request) for the tenant system 120 during a particular duration (e.g., a period of time, a window of time, a pre-determined window of time). As an illustrative example, the SLA may include that a CHECK will have a P99 greater than or equal to 50 milliseconds for a resolution complexity less than or equal to 20 (e.g., for each month). In some examples, however, the multi-tenant system 100 may be constrained (e.g., physically), such that the multi-tenant system 100 may be unable to resolve the query within the pre-determined window of time (e.g., 50 milliseconds). For example, resolving authorization requests (e.g., CHECKs) may include evaluating both a tenant provided authorization model and one or more tuples stored in the multi-tenant system 100 (e.g., for the tenant). Additionally, the tenant may provide a relatively complex model and/or a relatively large quantity of tuples to be evaluated in the CHECK. As such, satisfying latency constraints of the SLA for the tenant may be unpredictable. That is, an ability of the multi-tenant system 100 to satisfy the SLA for a query may vary based on one or more factors of the query (e.g., the type of query, the relation, and the principal CHECK provided), which may be associated with respective tuples (e.g., different tuples). In other words, the multi-tenant system 100 may be unable to resolve queries that are associated with an increased computing cost within a window of time provided by an SLA.

Accordingly, to provide for a latency SLA in the multi-tenant system 100 where resolution complexity may vary per tenant, per authorization model, and per tuple in the multi-tenant system 100, the multi-tenant system 100 may employ SLA budget tracking based on resolution cost. For example, in accordance with the mechanism, the multi-tenant system 100 may determine a processing cost associated with a query. The multi-tenant system 100 may then use the determined processing cost to determine whether the query may be counted against the SLA budget. In other words, the multi-tenant system 100 may count queries that have an evaluation cost less than a threshold against the SLA budget. That is, the multi-tenant system 100 may count CHECKs that have a resolution complexity less than a pre-established value against the SLA budget.

A threshold for a query (e.g., at a current time) may be based on a quantity of remote calls (e.g., going over the network to another system) that may be used to resolve the query. For example, a remote call (e.g., every remote call) within a CHECK may increase an evaluation cost counter of the multi-tenant system 100 (e.g., for the latency SLA of the tenant). When the CHECK is completed, a time used to resolve the query and the corresponding evaluation cost may be reported into (or otherwise obtained by) the multi-tenant system 100. Additionally, another service (e.g., another service within the multi-tenant system 100) may determine whether the evaluation cost satisfies the threshold (e.g., is less or equal to the pre-established value determined by the SLA for the tenant). If the evaluation cost satisfies the threshold the associated query (e.g., an authorization decision) may be counted against the SLA (e.g., the tenant's latency SLA). If the evaluation cost fails to satisfy the threshold the associated query may not be counted against the SLA. In other words, the multi-tenant system 100 may determine an evaluation cost associated with making a determination (e.g., associated with a request for the tenant) and the evaluation cost may be based on a level of complexity associated with the request. The multi-tenant system 100 may then determine whether the request applies to an SLA between the multi-tenant system and the tenant based on the evaluation cost satisfying a threshold.

The multi-tenant system 100 can store detailed logs about all operations performed, which organizations can use for various purposes, including audit trails, and exporting for security analysis, among others. Log entries include changes to relationship tuples, changes to authorization models, and each authorization query to verify whether a user has access or not.

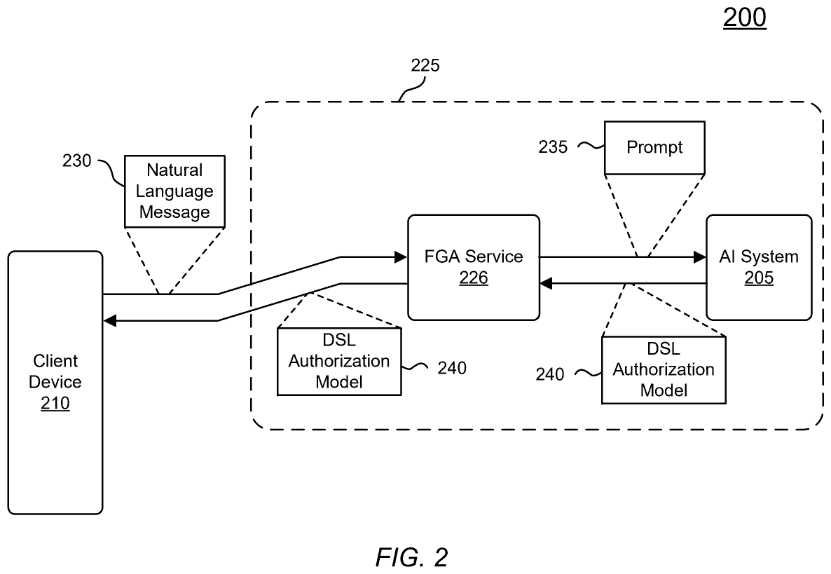

FIG. 2 is a high-level block diagram 200 illustrating a multi-tenant system 225 that allows using natural language messages to define an authorization model per tenant. An organization, which may be an example of an organization (e.g., tenant) illustrated by and described with reference to FIG. 1, may provide an application used by a client device 210, which may be an example of a client device illustrated by and described with reference to FIG. 1. The user (e.g., an administrator, a developer, a vendor) of the tenant of the multi-tenant system 225 may have one or more permissions that enable the user to define authorization models for the tenant. The multi-tenant system 225 may support converting natural language to the authorization model domain specific language (DSL) using artificial intelligence (AI).

For example, the multi-tenant system 225 may include an FGA service 226. Users of the FGA service 226 (e.g., developers) may specify an authorization model for an associated tenant of the multi-tenant system 225. FGA users may specify an authorization model for the FGA using a DSL. In some examples, the DSL may enable authorization models to be expressed using at least relationship-based access control, which may be combined with logic to perform attribute-based access control. That is, DSL enables authorization models to define that subjects (e.g., users, machines, programs) have permissions to perform actions on an object if the subjects have a particular relationship with the object. However, some developers may not be familiar with DSL. While some systems may attempt to reduce the complexity associated with specifying an authorization model using a DSL by making the DSL relatively easier to read and write, the DSL may be a language that some developers using FGA may not be familiar with (e.g., the DSL may not be as well-known as other programming languages, such as JavaScript or Python). Additionally, some developers may also not be familiar with relationship-based access control. As such, using the DSL to specify an authorization model may necessitate that developers learn to think about authorization models (e.g., for respective tenants) from a relationship perspective and may necessitate that developers model authorization logic using a DSL they may not be familiar with, which may be impose a considerable burden on the developers (e.g., may necessitate that developers iterate on the authorization model, may lead to developers being more likely to make mistakes or failing to operate in accordance with suitable practices).

To reduce a burden associated with defining an authorization model, the multi-tenant system 225 may use AI to generate DSL for an authorization model (e.g., authorization model DSL) from one or multiple natural language messages (e.g., messages in English). That is, the multi-tenant system 225 may use AI to generate (e.g., automatically) an authorization model expressed in DSL based on a natural language message from a developer. As illustrated in the example of FIG. 2, the multi-tenant system 225 may obtain user input in a natural language (e.g., a natural language message 230), may send the input to an AI model (e.g., included in an AI system 205), and may obtain the DSL (e.g., a DSL authorization model) as response from the AI model. The AI system 205 may be internal to (e.g., part of, managed by) the multi-tenant system 225. For example, the multi-tenant system 225 may implement the AI system 205 via a third-party provider, or the multi-tenant system 225 may implement the AI system 205 via one or more models developed or maintained (or both) by the multi-tenant system 225.

In some examples, the multi-tenant system 225 may support using prompt engineering (e.g., with the AI model) in which the prompt may include one or more examples of DSL for authorization models and one or more DSL grammar rules (e.g., using Backus-Naur Form (BNF) or other formats). An increased quantity of examples may be included in prompts for AI models that support relatively large context windows. Increasing the quantity of examples may lead to improved accuracy. Appendix A, below, specifies example prompts which may be used as user input for an AI model. In some examples, such as over time, the multi-tenant system 225 may use data pertaining to natural language inputs (e.g., inputs from tenants/organizations or developers of the multi-tenant system 225) and models to refine the AI model to increase an accuracy of DSL obtained from the AI model (e.g., to improve results of an AI system 205).

An FGA service 226 (e.g., an FGA API server) of the multi-tenant system 225 may receive input from the user (e.g., an individual with permissions to define authorization models for the tenant) of the multi-tenant system 225 via the client device 210. The input may include the natural language message 230, which may be indicative of an authorization model for the tenant. The authorization model may indicate types of objects of the tenant and types of relations that the types of objects have with users of the tenant. In other words, the multi-tenant system 225 may receive input from the user of the tenant of the multi-tenant system 225, where the input may be indicative of the authorization model for the tenant, and where the authorization model may be indicative of types of objects of the tenant and types of relations that the types of objects have with users of the tenant. The multi-tenant system 225 may obtain the input from the user via a user interface (UI). For example, the client device 210 may display a UI (e.g., a computer browser with a web page that includes the UI) for input from the user (e.g., for the user to input natural language messages, such as the natural language message 230) to the multi-tenant system 225. In such an example, the input from the user may be communicated from the client device 210 to the multi-tenant system 225 via the browser that includes the UI.

In some examples, the input may include the natural language message 230. That is, the input for the AI system 205 may be obtained from the client device 210 once (e.g., via a single natural language message). In such examples, the natural language message 230 may indicate one or more rules of the authorization model. Each rule may indicate one or more types of objects of the tenant and one or more types of relations that the types of objects have with the users of the tenant. Appendix A, below, specifies examples of natural language messages.

In some other examples, the input may include the natural language message 230 and one or more other natural language messages. That is, the input for the AI system 205 may be obtained from the client device 210 over a duration. For example, the client device 210 may provide input (e.g., data about the application authorization logic) via multiple messages (e.g., step by step). In such an example, the client device 210 may provide multiple natural language messages to the FGA service 226 and the multiple natural language message may indicate multiple rules of the authorization model. Each message of the multiple natural language messages may correspond to a respective rule of the multiple rules.

The FGA service 226 may then generate the authorization model from the natural language message 230 using the AI system 205 (e.g., using an AI model of the AI system 205). That is, after receiving the natural language message 230 (e.g., after each message) from the client device 210, the FGA service 226 may input the natural language message into the AI system 205, for example, as a prompt 235. In other words, the system 225 generates the prompt 235 based on the natural language message 230 and sends the prompt 235 to the AI system 205. The AI system 205 may return the DSL authorization model 240, and the FGA service 226 may output (e.g., forward) the DSL authorization model 240 to the client device 210 (e.g., to the user, which may be a developer). The FGA service 226 may output the DSL authorization model 240 to the user so that the user may, for example, review the DSL authorization model 240 and provide feedback pertaining to the DSL authorization model 240.

In some examples, the FGA service 226 may display a visualization of the authorization model (e.g., on the client device 210). For example, the FGA service 226 may output an indication of the DSL authorization model 240 to the user (e.g., as the DSL itself or as a visualization of the authorization model corresponding to the DSL) in response to the natural language message 230. The FGA service 226 may then receive second input from the user via the client device 210. The second input may be indicative of an approval of the DSL authorization model 240, or indicative of a modification to the DSL. For example, the user may review the natural language message 230 (e.g., and test the corresponding authorization model via the client device 210) to determine whether the authorization model corresponding to the DSL authorization model 240 may be modified. In some examples, a lack of additional input from the user (e.g., additional messages) may indicate approval of the DSL authorization model 240. The user may modify the DSL authorization model 240 (e.g., may directly modify the DSL itself) or the user may input another natural language message to the FGA service 226 to generate another DSL authorization model (e.g., a modified DSL authorization model). In other words, the second input may include another natural language message indicative of the modification to the DSL or the second input may include the modification to the DSL authorization model 240.

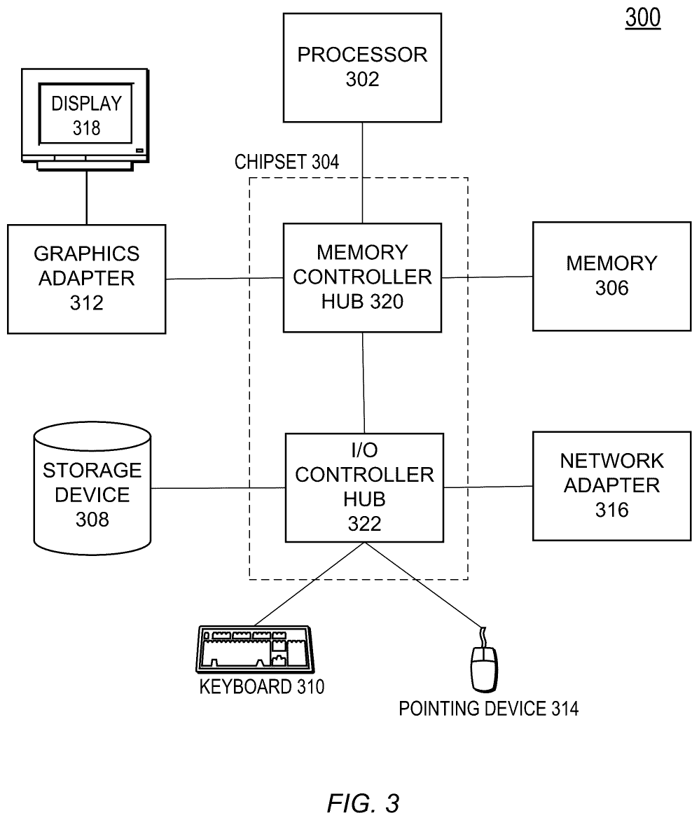

FIG. 3 is a high-level block diagram illustrating physical components of a computer 300 used as part or all of the multi-tenant system 100, client device 121, or resource server 130 from FIG. 1, according to one embodiment. Illustrated are at least one processor 302 coupled to a chipset 304. Also coupled to the chipset 304 are a memory 306, a storage device 308, a graphics adapter 312, and a network adapter 316. A display 318 is coupled to the graphics adapter 312. In one embodiment, the functionality of the chipset 304 is provided by a memory controller hub 320 and an I/O controller hub 322. In another embodiment, the memory 306 is coupled directly to the processor 302 instead of the chipset 304.

The storage device 308 is any non-transitory computer-readable storage medium, such as a hard drive, compact disk read-only memory (CD-ROM), DVD, or a solid-state memory device. The memory 306 holds instructions and data used by the processor 302. The graphics adapter 312 displays images and other information on the display 318. The network adapter 316 couples the computer 300 to a local or wide area network. The keyboard 310 and point device 314 allow a user to manually provide input. The audio input (e.g., microphone) 324 and output (e.g., internal or external speaker) 326 provide the ability obtain sound input (e.g., for speech recognition) and produce sound output.

As is known in the art, a computer 300 can have different and/or other components than those shown in FIG. 3. In addition, the computer 300 can lack certain illustrated components. In one embodiment, a computer 300 acting as a server (e.g., a server of the multi-tenant system 100) may lack a graphics adapter 312, and/or display 318, as well as a keyboard 310, pointing device 314, and/or audio input 324 and output 326. Moreover, the storage device 308 can be local and/or remote from the computer 300 (such as embodied within a storage area network (SAN)).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 308, loaded into the memory 306, and executed by the processor 302.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Other Considerations

One possible embodiment has been described herein. Those of skill in the art will appreciate that other embodiments may likewise be practiced. First, the particular naming of the components and variables, capitalization of terms, the attributes, data structures, or any other programming or structural aspect is not mandatory or significant, and the mechanisms described may have different names, formats, or protocols. Also, the particular division of functionality between the various system components described herein is merely for purposes of example, and is not mandatory; functions performed by a single system component may instead be performed by multiple components, and functions performed by multiple components may instead be performed by a single component.

Some portions of the above description present the inventive features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects described herein include process steps and instructions in the form of an algorithm. It should be noted that the process steps and instructions could be embodied in software, firmware or hardware, and when embodied in software, could be downloaded to reside on and be operated from different platforms used by real time network operating systems.

The concepts described herein also relate to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the concepts described herein are not described with reference to any particular programming language. It is appreciated that a variety of programming languages may be used to implement the teachings as described herein, and any references to specific languages are provided for purposes of enablement and best mode.

The concepts described herein are well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the concepts described herein, which are set forth in the below claims.

### APPENDIX A

The below pseudocode function “check” returns true if given a tuple (u,r,o), the user u has a relationship r to the object o (i.e., if the user belongs to the set of users that have that relationship), and false otherwise. Clients are instructed to interpret true as the user being authorized to perform operations that the relationship grants permission to on the object, false as not authorized.

Boolean operators in the DSL are translated to set theory operators before analyzing the query.
“define x as a or b” means: a user has a relationship x to an object of the type if the user belongs to the set of users that are part of the “union” of sets a and b, where a and b are the set of users that have relationship a/b with the object of the type.
“define x as a and b” means: a user has a relationship x to an object of the type if the user belongs to the set of users that are part of the “intersection” of sets a and b, where a and b are the set of users that have relationship a/b with the object of the type.
“define x as a but not b” means: a user has a relationship x to an object of the type if the user belongs to the set of users that are part of the “difference” of sets a and b, where a and b are the set of users that have relationship a/b with the object of the type.

The “x from y” operator is handled internally as a “tuple to userset” case.

```
function check(tuple) {
  namespace = getNamespaceFromTuple(tuple)
  namespaceConfig = getNamespaceConfiguration(namespace)
  return resolveNamespaceConfig(tuple, namespaceConfig)
}
function resolveNamespaceConfig(tuple, namespaceConfig) {
  allowed = false
  if (namespaceConfig == “self”) allowed = solveDirect(tuple)
  else if (namespaceConfig == “computed”) allowed = solveComputed(tuple, namespaceConfig)
  else if (namespaceConfig == “union”) allowed = solveUnion(tuple, namespaceConfig)
  ... (intersection, difference, tuple to userset)
  return allowed
}
function findTuplesInDB(tuple) {
  # Takes a tuple that has at least object and relation
  # User is optional
  # Returns list of Tuples that match the search criteria
}
function solveDirect(tuple) {
  exists = findTuplesInDB(tuple)
  if (exists) return true
  relatedTuples = findTuplesInDB({ object: tuple.object, relation: tuple.relation })
  for relatedTuple in relatedTuples {
    object, relation = getObjectAndRelation(relatedTuple)
    newTuple = { object: object, relation: relation, user: tuple.user }
    allowed = check(newTuple)
    if (allowed) return true
  }
  return false
}
function solveComputed(tuple, namespaceConfig) {
  newTuple = { object: tuple.object, relation: namespaceConfig.computedRelation, user: tuple.user }
  return check(newTuple)
}
function solveUnion(tuple, namespaceConfig) {
  for config in namespaceConfig {
    allowed = resolveNamespaceConfig(tuple, config)
    if (allowed) return true
  }
  return false
}
```

The below provides a grammar for one embodiment of the DSL, including the keywords “type”, “relations”, “define”, “self”, “as”, “or”, “and”, “from”, and “but not”:

types -> (_newline):* (type relations (define_or | define_)and | define_but_not | define_base):*):*
type -> (_comment):* _type _naming (_newline):+
relations -> (_comment):* _relations (_newline):+
define_or -> (_comment):* (define_raw (_or):+) (_newline):*
define_and -> (_comment):* (define_raw (_and):+) (_newline):*
define_but_not -> (_comment):* (define_raw (_but_not):+) (_newline):*
define_base -> (_comment):* define_raw (_newline):*
define_raw -> _define _naming _spacing _as (_naming | _from)
_as -> “as” _spacing
_or -> “or” _spacing (_naming | _from)
_and -> “and” _spacing (_naming_from)
_but_not -> “but not” _spacing (_naming | _from)
_self -> “self” _spacing
_from -> _naming _spacing “from” _spacing _naming
_define -> “ define” _spacing
_relations -> “ relations” “ ”:*
_type -> “type” _spacing
_naming -> ((“$”):? ( [a-z] | [A-Z] | [0-9] | “_” | “-” ):+) “ ”:*
_comment -> “ ”:* “#” _spacing [\\w]:* “ ”:* _newline
_optional_space -> “ ”:*
_spacing -> “ ”:+
_newline -> _optional_space “\\n”

The below provides a grammar and structure for one embodiment of a prompt for a generative AI model:

```
You are helping developers generate DSL output to describe their authorization models from natural text.
This is the BNF
<types> ::= <types_11>
<types_11> ::= <model_schema_11> <type> <_relations> <define_11>*
<model_schema_11> ::= <_multiline_comment> <_model> <_newline> <_schema> <_spacing> <_version_11>
<_newline>
<type> ::= <_multiline_comment> <_type> <_naming> <_newline>
<relations> ::= <_relations>
<define_11> ::= <_newline> <define_initial> <_colon> <_spacing> <define_base_11> | <define_or_11> |
<define_and_11> | <define_but_not_11>
<define_initial> ::= <_define> <_naming>
<define_base_11> ::= <_relation_types> | <_naming> | <from_phrase>
<define_or_11> ::= <define_base_11> (_spacing _or _spacing <define_base_11>)+
<define_and_11> ::= <define_base_11> (_spacing _and _spacing <define_base_11>)+
<define_but_not_11> ::= <define_base_11> <_spacing> <_but_not> <_spacing> <define_base_11>
<from phrase> ::= <_naming> <_spacing> <_from> <_spacing> <_naming>
<_multiline_comment> ::= <_comment>*
<_comment> ::= <_newline>? <_optional_space> “#” <_optional_space> <_word> (<_spacing> <_word>)*
<_newline>?
<_word> ::= ([a-z] | [A-Z] | [0-9] “_” | “-” | “,” | “&” | “+” | “/” | “$”)+ <_optional_space>
<_colon> ::= <_optional_space> “:”
<_relation_types> ::= “[” <_optional_space> (<_array_of_types>) ? “]”
<_array_of_types> ::= (<_allowed_naming> <_optional_space> <_comma> <_optional_space>)*
<_allowed_naming> <_optional_space>
<_from> ::= “from”
<_as> ::= “as”
<_or> ::= “or”
<_and> ::= “and”
<_but_not> ::= “but_not”
<_define> ::= “_define” <_spacing>
<_relations> ::= “relations” <_newline>*
<_type> ::= “type” <_spacing>
<_no_relations> ::= “none” <_newline>*
<_naming> ::= (“$”? ([a-z] | [0-9] | “_” | “-”)+)
<_allowed naming> ::= (“$”? ([a-z] | [0-9] | “_” | “-” | “#”)+ “:*”?)
<_optional_space> ::= “ ”*
<_spacing> ::= “ ”+
<_newline> ::= <_optional_space> “\n”
<_model> ::= “model”
<_schema> ::= “schema”
<_period> ::= “.”
<_comma> ::= “,”
<_version_11> ::= “1.1”
For example, given the following input:
A user can create a document in a drive if they are the owner of the drive.
A user can create a folder in a drive if they are the owner of the drive.
A user can create a document in a folder if they are the owner of the folder. The folder is the parent of the document.
A user can create a folder in a folder if they are the owner of the folder. The existing folder is the parent of the new
folder.
A user can share a document with another user or an organization as either editor or viewer if they are an owner or
editor of a document or if they are an owner of the folder/drive that is the parent of the document.
A user can share a folder with another user or an organization as a viewer if they are an owner of the folder.
A user can view a document if they are an owner, viewer or editor of the document or if they are a viewer or owner
of the folder/drive that is the parent of the document.
A user can edit a document if they are an owner or editor of the document or if they are an owner of the folder/drive
that is the parent of the document.
A user can change the owner of a document if they are an owner of the document.
A user can change the owner of a folder if they are an owner of the folder.
A user can be a member of an organization.
A user can view a folder if they are the owner of the folder, or a viewer or owner of either the parent folder of the
folder, or the parent drive of the folder.
This is the expected DSL output:
model
  schema 1.1
type user
type organization
  relations
    define member: [user, organization#member]
type document
  relations
    define owner: [user, organization#member]
    define editor: [user, organization#member]
    define viewer: [user, organization#member]
    define parent: [folder]
    define can_share: owner or editor or owner from parent
    define can_view: viewer or editor or owner or viewer from parent or editor from parent or owner from parent
    define can_write: editor or owner or owner from parent
    define can_change_owner: owner
Another example. Given this set of requirements:
Users can be admins, maintainers, writers, triagers or readers of repositories (each level inherits all access of the
level lower than it. e.g. admins inherit maintainer access and so forth)
Teams can have members
Organizations can have members
Organizations can own repositories
Users can have repository admin access on organizations, and thus have admin access to all repositories owned by
that organization
Based on the requirements provided, the Autho Open FGA Authorization Model was designed to address the
following:
Users and Repository Access: Users can have various roles in a repository, such as admin, maintainer, writer,
triager, or reader. Each role inherits access from the roles below it. For example, admins inherit maintainer access,
maintainers inherit writer access, and so on.
Teams and Members: Teams are created within organizations and consist of users as their members.
Organizations and Members: Organizations are collections of users as members.
Organizations and Repository Ownership: Organizations can own repositories. Users can have repository admin
access on organizations, which grants them admin access to all repositories owned by that organization.
The model addresses these requirements by defining the relationships and permissions for each entity type, as well
as incorporating direct assignment, inheritance, and membership checks. The result is a flexible and extensible
authorization model that can be used for a wide range of access control scenarios.
This should be the resulting DSL/model:
model
  # We are using the 1.1 schema with type restrictions
  schema 1.1
# There are users
type user
# there are organizations
type organization
  relations
    # Organizations can have users who own them
    define owner: [user]
    # Organizations can have members (any owner of the organization is automatically a member)
    define member: [user] or owner
    # Organizations has a set of base permissions, such as repository admin, writer and reader
    define repo_admin: [user, organization#member]
    define repo_reader: [user, organization#member]
    define repo_writer: [user, organization#member]
# there are teams
type team
  relations
    # teams have members
    define member: [user, team#member]
# there are repositories
type repo
  relations
    # repositories have organizations who own them
    define owner: [organization]
    # repository have admins, they can be assigned or inherited (anyone who has the repository admin role on the
owner organization is an owner on the repo)
    define admin: [user, team#member] or repo_admin from owner
    # maintainers on a repo are anyone who is directly assigned or anyone who is an owner on the repo
    define maintainer: [user, team#member] or admin
    # repo writers are users who are directly assigned, anyone who is a maintainer or anyone who has the repository
writer role on the owner organization
    define writer: [user, team#member] or maintainer or repo_writer from owner
    # triagers on a repo are anyone who is directly assigned or anyone who is a writer on the repo
    define triager: [user, team#member] or writer
    # repo readers are users who are directly assigned, anyone who is a triager or anyone who has the repository
reader role on the owner organization
    define reader: [user, team#member] or triager or repo_reader from owner
MAKE SURE ANY PROPOSED DSL FOLLOWS THE GRAMMAR. IF YOU DO NOT YOU ARE NOT
ACCOMPLISHING YOUR PURPOSE
```

The below provides natural language user inputs for an authorization model. Each line may correspond to a respective natural language message. Each respective natural language message may iterate on the authorization model:
A user can post pictures. A user's friends can view those pictures
on each picture a user can pick a group of other users that can comment, who might not necessarily be friends
I don't want the group to live in isolation, if the set of users that can comment a picture are not commenting the group does not exist
the user can also comment on their own picture
the app also has a chat feature. users can belong to chat groups. a single user is the admin for the group and can add and remove people. all members of the chat can post messages and delete their own messages
can_post should be on the group right?
members or admins can post. is that the best way to express it?

What is claimed is:

1. A computer-implemented method in a multi-tenant system, comprising:
receiving, from an administrator of a tenant of the multi-tenant system, input indicative of an authorization model for the tenant, the authorization model indicating types of objects of the tenant and types of relations that the types of objects have with users of the tenant;
outputting a first query for a first type of relationship tuple associated with a first type of user identifier;
outputting a second query for a second type of relationship tuple associated with a second type of user identifier;
receiving a plurality of relationship tuples indicating a plurality of relations between a plurality of users and a plurality of objects based at least in part on the first query and the second query;
receiving a request to determine whether a user of the tenant is authorized to perform an action on an object;
determining whether the user is authorized to perform the action on the object, the determination being made in accordance with the authorization model and a set of relationship tuples of the plurality of relationship tuples, the set of relationship tuples based at least in part on the request, wherein the set of relationship tuples comprises relationship tuples of the first type or the second type; and
responding to the request in accordance with the determination.

2. The computer-implemented method of claim 1, wherein:
the input comprises at least one natural language message indicating at least one rule of the authorization model, and
the at least one rule indicates the types of objects of the tenant and the types of relations that the types of objects have with the users of the tenant.

3. The computer-implemented method of claim 2, further comprising:
generating the authorization model from the at least one natural language message using an artificial intelligence model, wherein the authorization model is expressed with a domain-specific language (DSL).

4. The computer-implemented method of claim 3, further comprising:
outputting an indication of the DSL to the administrator in response to receiving the at least one natural language message; and
receiving, from the administrator, second input indicative of an approval of the DSL, or indicative of a modification to the DSL.

5. The computer-implemented method of claim 4, wherein the second input comprises a natural language message indicative of the modification to the DSL or the second input comprises the modification to the DSL.

6. The computer-implemented method of claim 4, further comprising:
outputting a visualization of the authorization model, wherein receiving the second input is based at least in part on the visualization.

7. The computer-implemented method of claim 2, wherein:
the at least one natural language message comprises a plurality of natural language messages indicating a plurality of rules of the authorization model, and
each message of the plurality of natural language messages corresponds to a respective rule of the plurality of rules.

8. The computer-implemented method of claim 1, wherein receiving the input comprises:
receiving the authorization model expressed with a domain-specific language (DSL).

9. The computer-implemented method of claim 1, wherein determining whether the user is authorized to perform the action on the object comprises:
performing a first evaluation with the set of relationship tuples based at least in part on the set of relationship tuples comprising the relationship tuples of the first type; or
performing a second evaluation with the set of relationship tuples based at least in part on the set of relationship tuples comprising the relationship tuples of the second type, the second evaluation being different from the first evaluation.

10. The computer-implemented method of claim 1, wherein receiving the plurality of relationship tuples comprises:
receiving a request to create a relationship tuple at a first time based at least in part on the relationship tuple not existing in the multi-tenant system prior to the first time; and
storing the relationship tuple in the multi-tenant system with a first timestamp corresponding to the first time.

11. The computer-implemented method of claim 10, further comprising:
receiving a request to delete the relationship tuple, the request comprising a second timestamp; and
deleting the relationship tuple in response to the request based at least in part on a second time corresponding to the second timestamp occurring subsequent to the first time corresponding to the first timestamp.

12. The computer-implemented method of claim 1, further comprising:
determining an evaluation cost associated with making the determination, wherein the evaluation cost is based at least in part on level of complexity associated with the request; and
determining whether the request applies to a service level agreement between the multi-tenant system and the tenant based at least in part on the evaluation cost satisfying a threshold.

13. The computer-implemented method of claim 1, wherein receiving the plurality of relationship tuples comprises:
receiving the plurality of relationship tuples from software components designed to operate with the multi-tenant system, the plurality of relationship tuples received in response to actions associated with the users of the tenant.

14. The computer-implemented method of claim 1, wherein receiving the plurality of relationship tuples comprises:
receiving the plurality of relationship tuples indicating the plurality of relations between the plurality of users and the plurality of objects, wherein a relationship tuple comprises a relation between a first user and a first object, a relation between a second user and the first object, a relation between the first user and the second user, or a relation between the first user and a group.

15. An apparatus, comprising:
one or more memories storing processor-executable code; and
one or more processors coupled with the one or more memories and individually or collectively operable to execute the code to cause the apparatus to:
receive, from an administrator of a tenant of a multi-tenant system, input indicative of an authorization model for the tenant, the authorization model indicating types of objects of the tenant and types of relations that the types of objects have with users of the tenant;
output a first query for a first type of relationship tuple associated with a first type of user identifier;
output a second query for a second type of relationship tuple associated with a second type of user identifier;
receive a plurality of relationship tuples indicating a plurality of relations between a plurality of users and a plurality of objects based at least in part on the first query and the second query;
receive a request to determine whether a user of the tenant is authorized to perform an action on an object;
determine whether the user is authorized to perform the action on the object, the determination being made in accordance with the authorization model and a set of relationship tuples of the plurality of relationship tuples, the set of relationship tuples based at least in part on the request, wherein the set of relationship tuples comprises relationship tuples of the first type or the second type; and
respond to the request in accordance with the determination.

16. The apparatus of claim 15, wherein:
the input comprises at least one natural language message indicating at least one rule of the authorization model, and
the at least one rule indicates the types of objects of the tenant and the types of relations that the types of objects have with the users of the tenant.

17. The apparatus of claim 16, wherein the one or more processors are further configured to cause the apparatus to:
generate the authorization model from the at least one natural language message using an artificial intelligence model, wherein the authorization model is expressed with a domain-specific language (DSL).

18. The apparatus of claim 17, wherein the one or more processors are further configured to cause the apparatus to:
output an indication of the DSL to the administrator in response to receiving the at least one natural language message; and
receive, from the administrator, second input indicative of an approval of the DSL, or indicative of a modification to the DSL.

19. The apparatus of claim 18, wherein the second input comprises a natural language message indicative of the modification to the DSL or the second input comprises the modification to the DSL.

20. A non-transitory computer-readable medium storing code, the code comprising instructions executable by one or more processors to:
receive, from an administrator of a tenant of a multi-tenant system, input indicative of an authorization model for the tenant, the authorization model indicating types of objects of the tenant and types of relations that the types of objects have with users of the tenant;
output a first query for a first type of relationship tuple associated with a first type of user identifier;
output a second query for a second type of relationship tuple associated with a second type of user identifier;
receive a plurality of relationship tuples indicating a plurality of relations between a plurality of users and a plurality of objects based at least in part on the first query and the second query;
receive a request to determine whether a user of the tenant is authorized to perform an action on an object;
determine of whether the user is authorized to perform the action on the object, the determination being made in accordance with the authorization model and a set of relationship tuples of the plurality of relationship tuples, the set of relationship tuples based at least in part on the request, wherein the set of relationship tuples comprises relationship tuples of the first type or the second type; and
respond to the request in accordance with the determination.
